(19) United States
(12) Patent Application Publication
(10) Pub. No.: US 2006/0103146 A1
(43) Pub. Date: May 18, 2006

(54) Motor vehicle lock

(76) Inventors: Jean-Pierre Noel, Raon L'Etape (FR); Philippe Ottolini, La Voivre (FR); Jean-Marc Belmond, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 11/272,046

(22) Filed: Nov. 10, 2005

(30) Foreign Application Priority Data
Nov. 12, 2004 (FR) 04 12 024

(51) Int. Cl. E05C 3/06

(52) U.S. Cl. 292/216

(57) ABSTRACT

A lock includes a housing, a claw outside the housing and a pawl acting on the claw that is inside the housing. The pawl is less exposed to the environment and is better protected, improving the lifetime of the lock.

### REFERENCE TO RELATED APPLICATION

This application claims priority to French Patent Application FR 04 12 024 filed on Nov. 12, 2004.

### BACKGROUND OF THE INVENTION

This invention relates generally to motor vehicle locks.

Locks are mounted on a door edge, and their mechanism is exposed to dust, moisture, etc. This exposure can be prejudicial to the operation and lifetime of the lock.

There is a need to protect locks and thus to increase their lifetime.

### SUMMARY OF THE INVENTION

The present invention provides a lock including a housing, a claw located outside of the housing, and a pawl that activates the claw that is located inside the housing.

According to one variant, the housing includes a cavity opening to the outside of the housing, and the claw is inside the cavity. According to one variant, the housing includes an opening through which the pawl activates the claw. According to one variant, the lock also includes a retainer plate for attaching the housing to a vehicle, and the claw is located between the retainer plate and the housing.

According to one variant, the lock also includes a pawl shaft on which the pawl is rotatably mounted, and a play adjustment plate is along the pawl shaft. According to one variant, the adjustment plate is deformable along the pawl shaft. According to one variant, the adjustment plate has flanges designed to be deformed along the pawl shaft.

According to one variant, the lock also includes an external opening lever that rotates around the pawl shaft. The external opening lever is able to activate the pawl and an internal opening counter-pawl that rotates around the pawl shaft. The adjustment plate adjusts the play between the external opening lever, the counter-pawl and the pawl.

According to one variant, the lock also includes a claw shaft around which the claw can rotate. The adjustment plate maintains the axle spread between the pawl shaft and the claw shaft.

### BRIEF DESCRIPTION OF THE DRAWINGS

Other characteristics and advantages of the invention will become apparent on reading the following detailed description of the embodiments of the invention, given as an example only, and with reference to the drawings, which show:

FIG. 1 illustrates a perspective view of a lock;

FIG. 2 illustrates a perspective view of the lock according to one embodiment of the invention;

FIG. 3 illustrates a sectional view along line A-A of the lock in FIG. 2;

FIG. 4 illustrates a detail view of the lock according to FIG. 3; and

FIG. 5 illustrates a perspective view of an adjustment plate according to one example of the invention.

### DETAILED DESCRIPTION OF THE INVENTION

The invention refers to a lock including a housing, a claw and a pawl. The claw is activated by the pawl. The pawl is located inside the housing. Thus, the pawl is less exposed to the environment and is better protected, increasing the lifetime of the lock.

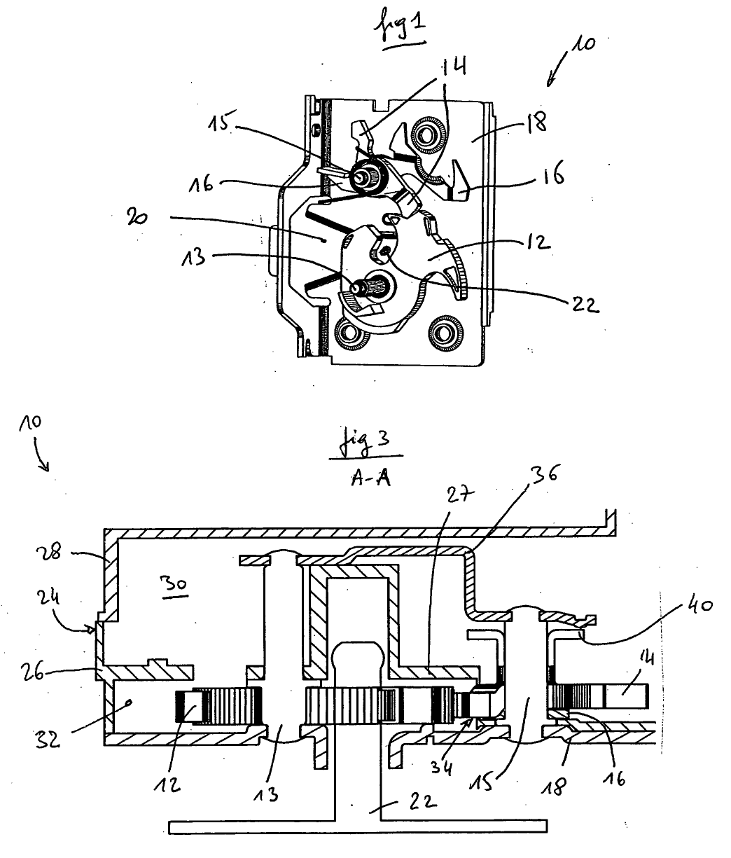

FIG. 1 shows a perspective view of a lock 10. A lock 10 of this kind allows an opening of a motor vehicle to be maintained in a closed position. It also allows the opening to be released by action on an internal or external opening control connected to the lock 10 that can be activated by a user. The lock 10 is typically mounted on the vehicle opening.

A claw 12, a pawl 14 and a counter-pawl 16 are shown. The claw 12 is mounted rotatably on a claw shaft 13, and the pawl 14 and the counter-pawl 16 are mounted rotatably on a pawl shaft 15. According to FIG. 1, these components are mounted on a retainer plate 18 that secures the lock 10 to a vehicle door. The retainer plate 18 includes an aperture 20 into which a striker 22 is inserted. The claw 12 secures the striker 22 (which is mounted on the vehicle) relative to the lock 10 or conversely releases the striker 22. Releasing the striker 22 is called opening the lock 10, which releases the opening. Conversely, holding the striker 22 in the lock 10, which prevents the opening from being released, is called closing the lock 10. The claw 12 is pushed towards a closed position by the striker 22 when the opening is closed, and the pawl 14 prevents the claw 12 from returning to an open position and keeps the claw 12 in the closed position in the absence of external action on the lock 10.

In FIG. 1, the lock 10 is closed and the striker 22 is held by the claw 12. The lock 10 includes an external opening lever 40, not shown in the exploded diagram in FIG. 1. The pawl 14 in turn acts on the claw 12 to release the striker 22. The pawl 14 acts on the claw 12 to release the claw 12, allowing the claw 12 to return in a counter-clockwise direction to the open position.

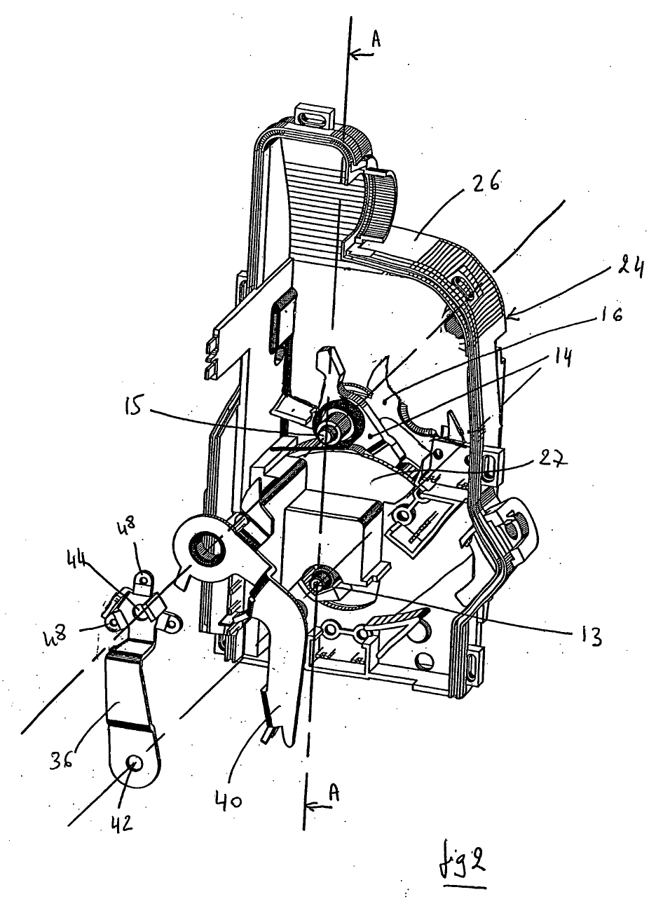

FIG. 2 shows a perspective view of the lock 10 according to one example of the invention. The lock 10 includes a housing 24 having a lower part 26 onto which a cover 28 is fitted, shown in FIG. 3. In FIG. 2, the cover 28 has been removed, enabling the mechanism of the lock 10 to be seen. Only the pawl 14 and the counter-pawl 16 are visible. The pawl 14 is located inside the housing 24, providing improved protection of the pawl 14 against environmental stresses, such as dust. FIG. 2 also shows an adjustment plate 36, the function of which will be described in more detail below.

FIG. 3 shows a sectional view of the lock 10 along line A-A of FIG. 2. The cross-section is shown in diagrammatic form for improved understanding. In FIG. 3, the housing 24 is shown, and its wall includes the cover 28 that cooperates with the lower part 26 of the housing 24. FIG. 3 also shows the pawl 14 and the counter-pawl 16 mounted rotatably on the pawl shaft 15. The pawl 14 is in contact with the claw 12 to activate the claw 12.

The pawl 14 is inside 30 the housing 24, while the claw 12 is outside the housing 24. The housing 24 includes a cavity 32 facing the outside of the housing 24 in which the claw 12 is located. The pawl 14 is mounted in the housing 24, and the claw 12 is opposite the pawl 14 in the cavity 32. The cavity 32 is an indentation in the housing wall. The wall of the housing 24 thus includes a step 27, allowing the pawl 14 inside 30 the housing 24 and the claw 12 outside the housing 24 to be arranged on approximately the same plane. In particular, the cavity 32 is an indentation in the lower part 26 of the housing 24. The claw 12 is housed in the cavity 32, outside the housing 24, allowing the striker 22 to cooperate with the claw 12 to close the lock 10.

In addition, the lock 10 can include the retainer plate 18 for attaching the housing 24 to a vehicle, in this case to an opening of the vehicle. The lock 10 is fixed to the retainer plate 18 by the lower part 26 of the housing 24. As the cavity 32 is an indentation in the lower part 26, the lower part 26 rests partially on the retainer plate 18. The retainer plate 18 obturates the cavity 32 at least partially, allowing the claw 12 to be confined within the cavity 32. The retainer plate 18 further assists in holding the claw 12 in place.

The housing 24 includes an opening 34 through which the pawl 14 activates the claw 12. Thus, while the claw 12 is outside the housing 24, the pawl 14 is protected inside 30 the housing 24 while remaining in contact with the claw 12. The size of the opening 34 limits particles that damage the operation of the lock 10 from entering the housing 24. The opening 34 is, for example, in the edge of the step 27 in the wall of the housing 24. The opening 34 is close to the lower part 26, allowing the pawl 14 to be mounted on the lower part 26 and to cooperate with the claw 12 opposite the pawl 14. The pawl 14 is able to partially protrude from the housing 24 to activate the claw 12. However, the articulation of the pawl 14 around the pawl shaft 15 remains within the housing 24 in such a way as to protect the articulation from external stresses.

The lock 10 can also contain an adjustment plate 36 that reinforces the lock 10. As the components of a lock 10 are moved together, the relative positioning of these components is important. Further, lock components are subject to severe stresses. For example, the action of the striker 22 on the claw 12 when the door is closed places strain on the axle spread between the claw shaft 13 of the claw 12 and the pawl shaft 15 of the pawl 14. The adjustment plate 36 allows the lock 10 to be more rigid. For example, the adjustment plate 36 maintains the axle spread between the claw shaft 13 and the pawl shaft 15. The adjustment plate 36 is in the housing 24. Thus, it can be seen in FIG. 3 that the ends of each of the claw shaft 13 and the pawl shaft 15 in the housing 24 are connected together by the adjustment plate 36. As the adjustment plate 36 is rigid, it allows for the center distance to be kept constant. The retainer plate 18 also maintains the center distance at the other end of each of the claw shaft 13 and the pawl shaft 15. The claw shaft 13 and the pawl shaft 15 can be riveted to the retainer plate 18 and to the adjustment plate 36. The adjustment plate 36 is preferably made of metal. The presence of the adjustment plate 36 to stiffen the lock 10 also allows the housing 24 to be manufactured from a plastic material at a lower cost.

The adjustment plate 36 also provides for adjustment of play along the pawl shaft 15 of the pawl 14. The effect of the adjustment plate 36 is to position the pawl 14 suitably along the pawl shaft 15 relative to the claw 12. This positioning ensures correct operation of the claw 12 by the pawl 14, i.e., the immobilization or release of the claw 12 by the pawl 14 and thus correct operation of the lock 10.

FIG. 3 also shows that the pawl shaft 15 is the axis of rotation of the counter-pawl 16 and the external opening lever 40. The external opening lever 40 allows the pawl 14 to be operated from outside the vehicle by an external opening control (not shown). The counter-pawl 16 ensures the internal opening of the vehicle by an internal opening control (not shown). The pawl 14, the counter-pawl 16, and the external opening lever 40 are co-axial and are assembled one on top of the other as in a “stack.” This saves space inside the housing 24. According to FIG. 3, the counter-pawl 16 is against the lower part 26 of the housing 24, the pawl 14 is assembled on the counter-pawl 16, and the external opening lever 40 is assembled on top of both of them. The presence of the pawl 14 in the housing 24 offers more freedom in the order of assembly, facilitating the assembly of the lock 10. In fact, the pawl 14 can be assembled advantageously between the counter-pawl 16 and the external opening lever 40, as the two latter components are designed to activate the pawl 14 to open the lock 10. The pawl 14 can be provided with an elbow to have one end in contact with the claw 12.

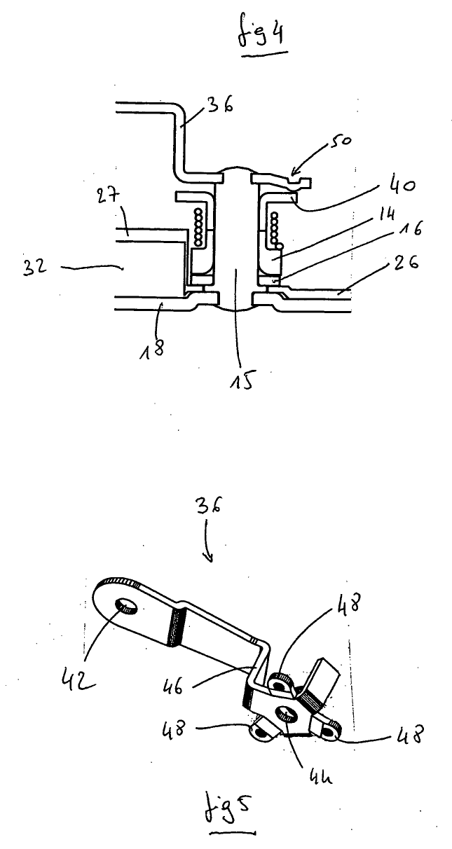

The adjustment plate 36 allows the pawl 14, the counter-pawl 16 and the external opening lever 40 to be held in place along the pawl shaft 15. In addition, the adjustment plate 36 allows for the play along the pawl shaft 15 to be adjusted, as shown in FIG. 4. The pawl 14, the counter-pawl 16 and the external opening lever 40 have an operating play adjusted, taking into account the limitation of the movement of the components along the pawl shaft 15 while limiting the jamming of the components in their rotation. Assembly on the pawl shaft 15 is optimized, which as emphasized above improves the operation of the lock 10.

FIG. 4 shows a detail view of a section through the lock 10. This figure shows an example of the adjustment of the play along the pawl shaft 15 by the adjustment plate 36.

According to this figure, adjustment of play is carried out by deformation of the adjustment plate 36 along the pawl shaft 15. The adjustment plate 36 is deformed at one end 50 in the direction of the external opening lever 40. The adjustment plate 36 is indented axially. This deformation allows for adjustment of the play in the components along the pawl shaft 15. The axial deformation of the adjustment plate 36 allows for rapid and simple adjustment of the play without, in particular, the use of any additional parts. The adjustment of play is also more accurate.

FIG. 5 shows a three-dimensional view of the adjustment plate 36. The adjustment plate 36 includes holes 42 and 44 for the passage of the claw shaft 13 and the pawl shaft 15. The adjustment plate 36 can also include a shoulder 46 for fitting inside the housing 24, in particular against the step 27 in the housing wall. The adjustment plate 36 can include flanges 48 to carry out the axial adjustment along the pawl shaft 15. To carry out the axial adjustment, it is possible, for example, to use a tool straddling the adjustment plate 36 and resting on the external opening lever 40 (FIG. 4). This allows for the position of the external opening lever 40 along the pawl shaft 15 to be known. The tool then pushes the flanges 48 towards the external opening lever 40 until the required tightness is obtained. Use of the deformable flanges 48 allows the tool to rest on the external opening lever 40 between the flanges 48. The adjustment plate 36 may, for example, include three flanges 48 separated at an angle with the same angle between them. This allows the adjustment plate 36 to adjust the play on the external opening lever 40 in an isostatic manner.

Of course, this invention is not limited to the embodiments described as examples. It is thus possible to consider the adjustment plate 36 independently of the presence of the pawl 14 in the housing. In effect, whether or not the pawl 14 is in the housing 24, the adjustment plate 36 allows adjustment of the play of the components assembled along the shaft. However, when the pawl 14 is in the housing 24, the play of the pawl 14 is also adjusted relative to the other components, which improves the operation of the lock 10.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A lock comprising:
a housing;
a claw located outside the housing; and
a pawl acting on the claw, wherein the pawl is located inside the housing.

2. The lock according to claim 1, wherein the housing includes a cavity open to outside of the housing, and the claw is located inside the cavity.

3. The lock according to claim 1, wherein the housing includes an opening through which the pawl activates the claw.

4. The lock according to claim 1, further including a retainer plate to attach the housing to a vehicle, wherein the claw is located between the retainer plate and the housing.

5. The lock according to claim 1, further including an adjustment plate, wherein the pawl is rotatably mounted around a pawl shaft and the adjustment plate adjusts play along the pawl shaft.

6. The lock according to claim 5, wherein the adjustment plate is deformable along the pawl shaft.

7. The lock according to claim 5, wherein the adjustment plate includes flanges deformable along the pawl shaft.

8. The lock according to claim 5, further including an external opening lever rotating on the pawl shaft and an internal opening counter-pawl rotating on the pawl shaft, wherein the external opening lever activates the pawl, and the adjustment plate adjusts the play between the external opening lever, the internal opening counter-pawl and the pawl.

9. The lock according to claim 5, wherein the claw rotates around a claw shaft, and the adjustment plate maintains an axle spacing between the pawl shaft and the claw shaft.

10. A lock comprising:
a housing;
a claw located outside the housing;
a pawl acting on the claw, wherein the pawl is located inside the housing;
a pawl shaft around which the pawl is rotatably mounted; and
an adjustment plate for adjusting play along the pawl shaft.

11. The lock according to claim 10, wherein the housing includes a cavity open to outside of the housing, and the claw is located inside the cavity.

12. The lock according to claim 10, wherein the housing includes an opening through which the pawl activates the claw.

13. The lock according to claim 10, wherein the adjustment plate is deformable along the pawl shaft.

14. The lock according to one of claim 10, wherein the adjustment plate includes flanges deformable along the pawl shaft.

15. The lock according to claim 10, further including an external opening lever rotating on the pawl shaft and an internal opening counter-pawl rotating on the pawl shaft, wherein the external opening lever activates the pawl, and the adjustment plate adjusts the play between the external opening lever, the internal opening counter-pawl and the pawl.

16. A lock comprising:
a housing;
a claw located outside the housing;
a pawl acting on the claw, wherein the pawl is located inside the housing;
a pawl shaft around which the pawl is rotatably mounted;
an adjustment plate for adjusting play along the pawl shaft;
an external opening lever rotating on the pawl shaft, wherein the external opening lever activates the pawl; and
an internal opening counter-pawl rotating on the pawl shaft, wherein the adjustment plate adjusts the play between the external opening lever, the internal opening counter-pawl and the pawl.

17. The lock according to claim 16, wherein the housing includes a cavity open to outside of the housing, and the claw is located inside the cavity.

18. The lock according to claim 16, wherein the adjustment plate is deformable along the pawl shaft.

19. The lock according to claim 16, wherein the claw rotates around a claw shaft, and the adjustment plate maintains an axle spacing between the pawl shaft and the claw shaft.
